(19) United States
(12) Patent Application Publication
(10) Pub. No.: US 2025/0371620 A1
(43) Pub. Date: Dec. 4, 2025

(54) SYSTEMS AND METHODS FOR ENHANCED CONTACTLESS COMMUNICATION

(71) Applicant: MASTERCARD INTERNATIONAL INCORPORATED, PURCHASE, NY (US)

(72) Inventors: Ajay Bahadur Singh Panwar, Pune (IN); Kaushal Shetty, O'Fallon, MO (US); Mayank Joshi, Pune (IN)

(21) Appl. No.: 18/676,226

(22) Filed: May 28, 2024

(51) Int. Cl. G06Q 40/06; G06Q 30/018

(52) U.S. Cl. CPC G06Q 40/06; G06Q 30/018

(57) ABSTRACT

Systems and methods are provided for assessing data related to transactions initiated by users. An example method generally includes providing one or more payment options to a user for a transaction; in response to selecting one of the one or more payment options, displaying, to the user, by a computing device, a plurality of authentication options corresponding to a selected one of the payment options along with one or more environmental, social and governance (ESG) related scores for each authentication option; receiving a selection of one of the plurality of authentication options; and processing a payment for the transaction using the selected one of the plurality of authentication options.

### FIELD

The present disclosure generally relates to systems and methods for enhancing contactless communication, and in particular, to systems and methods related to enhanced frictionless payment schemes related to environmental, social and governance (ESG) impact.

### BACKGROUND

This section provides background information related to the present disclosure which is not necessarily prior art.

Assessments are known to evaluate different users, entities, etc. (broadly, parties) on a number of difference bases, where the assessments may indicate a compliance of the party with one or more standards or initiatives, etc. Environmental, social and governance or ESG is one example framework used to assess the parties' practices and performances relative to ESG goals, objectives, initiatives, and issues. ESG scores, then, may be used by the parties as bases for comparison on relevant goals, objectives, initiatives, and/or issues, with relation to other parties.

### DRAWINGS

The drawings described herein are for illustrative purposes only of selected embodiments and not all possible implementations, and are not intended to limit the scope of the present disclosure.

FIG. 1 is an example system of the present disclosure suitable for use in assessing and, potentially, addressing economic, social and governance (ESG) objectives related to payment account transactions initiated by users;

FIG. 2 is a block diagram of an example computing device that may be used in the system of FIG. 1;

FIG. 3 is an example method that may be implemented in connection with the system of FIG. 1, or otherwise, for assessing and, potentially, addressing ESG objectives related to payment account transactions initiated by users; and

FIG. 4 illustrates multiple example interfaces, which may be presented to a user in connection with the method of FIG. 3.

Corresponding reference numerals indicate corresponding parts throughout the several views of the drawings.

### DETAILED DESCRIPTION

Example embodiments will now be described more fully with reference to the accompanying drawings.

Parties engage in a variety of activities that generally may be interpreted in connection with one or more issues, especially, environmental social and governance (ESG) goals, initiatives, and issues (broadly, objectives). Parties often impose limitations, identify initiatives, or set goals, relative to such ESG assessments, to provide improvement based on associated measures related to the same. Often, there is limited ability to assess activities related to the ESG objectives, as the impact may be obscured or not readily apparent. Accordingly, the activities may be undertaken with less than full understanding on their impacts to the ESG objectives more specifically. Payment account cards, for example, may be associated with limited ESG performance, due to prevalence of non-frictionless options or limited frictionless payment options. As such, in the context of ESG, there is a technical problem related to the accurate assessment of ESG impact to help parties realize the ESG objectives of friction-type payments, and aid the parties in making other decisions to improve such ESG objectives.

Uniquely, the systems and methods herein enable realization of the impact of certain types of payment transactions in connection with certain assessments (e.g., ESG assessments, etc.), and promote one or more types of payment transactions (i.e., frictionless payments) in a manner to improve performance according to the assessments.

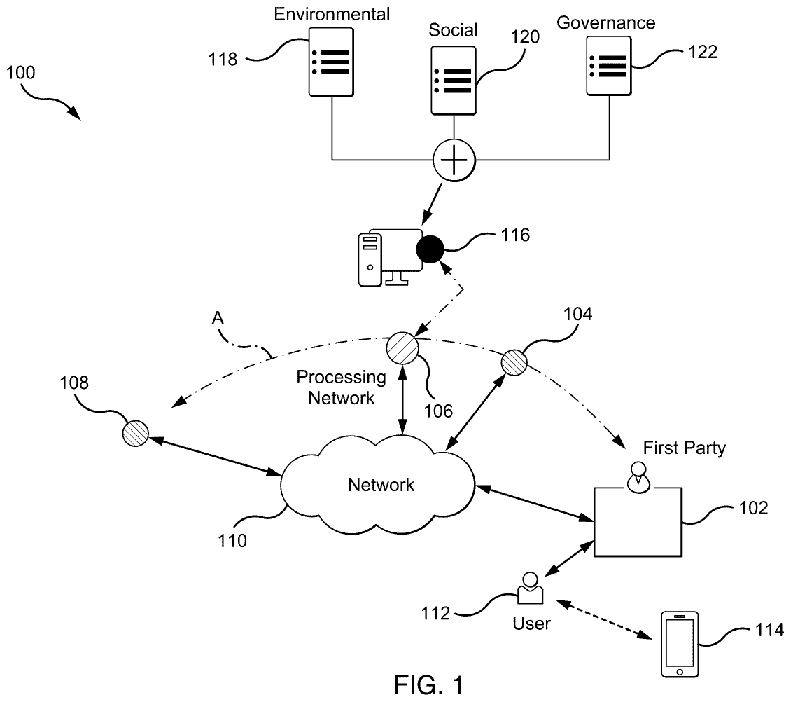

FIG. 1 illustrates an example system 100 in which one or more aspects of the present disclosure may be implemented. Although the system 100 is presented in one arrangement, other embodiments may include systems arranged otherwise depending, for example, on processing of transactions, storing transaction data, privacy rules, regulations, and/or concerns, etc.

In the illustrated embodiment, the system 100 generally includes a first party 102, an acquirer 104, a processing network 106, and an issuer 108, each coupled to (and in communication with) a network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the processing network 106 to the acquirer 104 and the issuer 108 and, separately, the public Internet, which is accessible as desired to the first party 102, the processing network 106, the issuer 108, and one or more various users in the system 100 (e.g., user 112, etc.), etc.

The first party 102 in the system 100 is generally a merchant associated with offering products (e.g., goods and/or services, etc.) for purchase to one or more users (including user 112). The first party 102 may offer the products for sale through a physical storefront and/or a virtual storefront, etc., for example, to the user 112. It should be appreciated that the first party 102 may be one or more different types of merchants, offering for sale various different types of products, etc.

In this example embodiment, the acquirer 104 is generally a financial institution, such as, for example, a bank. The acquirer 104 is configured to issue an account to the first party 102. The account may be a payment account, or checking account, or other type of account, into which the first party 102 is permitted to receive funds.

Similarly, in this example embodiment, the issuer 108 is generally a financial institution, such as, for example, a bank. The issuer 108 is configured to issue an account to the user 112. The account may be a payment account or other type of account from which the user 112 is permitted to pay funds. Further, in this example embodiment, the account issued to the user 112 is a credit, debit or prepaid account, which is associated with a primary account number or PAN. The PAN may be, for example, embossed on a front/back of a physical payment card for the account, or encoded into the physical payment card, or provisioned to an electronic/virtual wallet included in a communication device 114 associated with the user 112. In this way, the user 112 is permitted to present the account to the first party 102, for example, to identify the account, via the PAN, by entering the PAN to an interface, by swiping or tapping the physical payment card, or otherwise, etc. In addition to the acquirer 104 and the issuer 108, the processing network 106 is configured to coordinate messaging between the acquirer 104 and the issuer 108 (e.g., consistent with the ISO 8583 standard, ISO 20022 standard, etc.) in order to facilitate payment account transactions (e.g., between the first party 102 and the issuer 112, etc.). The processing network 106 may include, for example, the MASTERCARD, VISA, or DISCOVER processing network, etc.

As shown in FIG. 1, the user 112 is also associated with the communication device 114. The communication device 114 may include a mobile device, such as, for example, a smartphone, a tablet, a laptop, or an immobile device, such as, for example, a personal computer, a desktop, a workstation, etc. The communication device 114 is configured to communicate, through the network 110, for example, with the first party 102, the issuer 108, etc.

In connection with an example transaction, the user 112 presents his/her account to the first party 102 (e.g., by physically swiping a payment card, entering the PAN, logging into a user account with the first party 102, etc.) (or specifically, at a point of sale (POS) terminal of the first party 102, etc.). In response, the first party 102 is configured to generate an authorization message (i.e., authorization request in this instance) for the transaction to be funded by the user's account and to communicate the authorization message (e.g., consistent with the ISO 8583 standard, ISO 20022 standard, etc.) to the acquirer 104 (along path A in FIG. 1). The authorization message includes various details of the transaction, such as, for example, the amount, transaction type (e.g., card present, card-not-present, frictionless, etc.), PIN (e.g., via the POS terminal, etc.), OTP (e.g., associated with user account, etc.), merchant ID, time/date, PAN, CVC, expiration date, MCC, merchant name and address, acquirer ID, etc.

In turn, the acquirer 104 communicates the authorization request, along path A, generally to the processing network 106, such as, for example, through the MASTERCARD, VISA, or DISCOVER processing network, etc. The processing network 106 is configured to transmit the authorization message to the issuer 108 (along path A in FIG. 1). The issuer 108 is configured to approve or decline the transaction based on, for example, balance, available credit, standing, etc., associated with the user 112 (and/or the user's account). The issuer 108 is configured to then compile an authorization message (i.e., an authorization reply in this instance) and to transmit the authorization message to the acquirer 104, via the processing network 106. The acquirer 104 is configured, in turn, to store the authorization message (and any codes associated therewith) and to transmit the authorization message back to the first party 102.

The transaction is later cleared and/or settled (via appropriate transaction messages such as clearing messages and/or settlement messages) by and between the first party 102, the acquirer 104, and the issuer 108, based on the appropriate arrangement, via the processing network 106.

Transaction data is generated, collected, and stored as part of the above interactions among the first party 102, the acquirer 104, the processing network 106, and the issuer 108 (and included in the various messages). The transaction data represents at least a plurality of transactions, for example, authorized transactions, cleared and/or settled transactions, attempted transactions, etc. The transaction data, in this example embodiment, is stored at least by the processing network 106 and the issuer 108 (e.g., in a data structure associated with the processing network 106 (or the issuer 108), etc.), but could be stored in other parts of the system 100 and transmitted as needed or requested. The transaction data may include, for example, primary account numbers (PANs) for users involved in the transactions, amounts of the transactions, transaction types, times/dates, MCCs, first party data, and also, transaction Location, transaction frequency, product/service information, currency exchanges, transaction purpose/reason, shipping instructions/addresses, additional carbon emission data, relevant supply chain information, etc. It should be appreciated that more or less information related to transactions, as part of either authorization or clearing and/or settling, may be included in transaction records and stored within the system 100, at the first party 102, the acquirer 104, the processing network 106 and/or the issuer 108.

It should be appreciated that transaction data is collected, stored and accessed as described herein pursuant to and/or based on specific permission to do so from one or more parties associated with the transaction data (e.g., the user 112, the issuer 108, etc.).

With continued reference to FIG. 1, the system 100 further includes a program host 116, which is configured to perform an assessment of transactions in the system 100 (e.g., as processed through the processing network 106, etc.) and to promote one or more types of payments (e.g., frictionless payments, etc.) as it relates to improving performance of/for the user 112 (e.g., use by the user 112 of his/her account, etc.) and/or the associated account(s) in the assessment. In this embodiment, the assessment is specific to environmental social and governance (ESG) objectives.

As shown in FIG. 1, in this example, the program host 116 is a stand alone computing device, which is in communication with one or more of the acquirer 104, the processing network 106, and the issuer 108. That said, it should be appreciated that the program host 116 may be integrated, in whole or in part, with either of the processing network 106 (e.g., the MASTERCARD processing network, etc.) or the issuer 108, for example, as a value-added services, etc.

In this example embodiment, the program host 116 includes a data structure, which, in turn, includes transaction data associated with the account issued to the user 112 by the issuer 108 and representative of various transactions thereto, as explained above. Among other things, the transaction data is indicative of the type of each transaction performed by the user 112 and/or involving the user's account, where, in this example, the type is (or is indicative of) either a friction (or non-frictionless) transaction by the user 112 (and/or to the user's account) or a frictionless transaction. In this example embodiment, the frictionless transactions should be understood to include instances in which the user experiences limited or minimal obstacles or disruptions during a payment flow. Examples of frictionless transactions include contactless payment, one-click purchase, biometric authentication, auto-renewal subscriptions, tokenization, etc. Specifically, for example, contactless payment relies on using technologies, such as, for example, NFC (near-field communication), or mobile wallets for transactions, where there is no need for physical contact/connection between a physical payment card and the POS terminal of the first party 102. One-click purchases, on the other hand, rely on an online platform of the first party 102, which stores user information for the user 112 and allows purchases with about five or fewer (e.g., one, etc.) clicks, thereby reducing the number of steps associated with the transaction. Biometric authentication then relies on payments authenticated through presentation of biometric data (e.g., fingerprint, facial recognition, etc.) to eliminate the need for the user 112 to manually enter a password or PIN. Auto-renewal subscriptions are categorized in reliance on automatically renewing subscriptions of the user 112, without requiring the user 112 to manually initiate the renewal each time. And, tokenization relies on substituting sensitive card details with a unique token, enhancing security and simplifying the steps of the transaction.

Conversely, examples of friction or non-frictionless transactions include, specifically, manual entry of payment card data (i.e., manually typing in PAN, expiration date, CVC, etc.), multi-step checkout processes (i.e., online transactions with lengthy and complex checkout processes, which is more than five clicks, involving multiple forms and steps), two-factor authentication (2FA), which requires the additional steps of 2FA to introduce friction for the user 112, offline transactions, and declined transactions.

The program host 116 also collects, solicits, stores and includes additional data related to (or indicative of) the environmental, social and governance data related to the user's transaction activities (e.g., of the transactions performed by the user 112, etc.). Specifically, the program host 116 includes data such as, for example, electricity usage (i.e., data indicative of energy consumption associated with the transactions, particularly relevant for online or digital transactions), carbon emission data (i.e., data indicating the carbon footprint of the transactions, providing insights into their environmental impact), ethical data (i.e., details related to the ethical considerations of the transactions, such as the ethical practices of involved parties (merchants, service providers, etc.)), supply chain information (i.e., data on the supply chain practices for products involved in transactions, offering a perspective on sustainability), transaction purpose data (i.e., indicative of purpose or category of each transaction to assess its alignment with specified environmental, social, and/or governance criteria), and industry-specific metrics (e.g., depending on the industry, specific metrics or data related to environmental and social responsibility may be relevant, etc.).

In addition, in this example embodiment, the program host 116 also stores or includes an ESG framework, which is a set of rules and criteria for assessing the environmental, social and governance aspects of transactions to the user's account. The ESG framework may include factors related to, without limitation, environmental impact (e.g., assesses resource-intensive processes (e.g., energy consumption, carbon emissions, etc.) for each transaction and defines a manner of assigning a score based on the objectives for the transaction's environmental footprint, etc., social implications (e.g., analyzes the social implications of transactions (e.g., customer satisfaction, inclusivity, data privacy), and defines a manner of assigning a score based on social objectives demonstrated by the transaction, etc.), governance aspects (e.g., assesses governance aspects related to payment practices (e.g., transparency, compliance, ethical practices) and defines a manner of assigning a score based on the transaction's adherence to governance objectives (e.g., standards, etc.), etc.), etc.

Additional details on the environmental, social and governance impacts and associated scores are presented in Table 1, below.

TABLE 1

| | |
|---|---|
| Environmental | Calculation Basis: Evaluates environmental impact of resource- |
| Score: | intensive processes (e.g., energy consumption, carbon emissions, waste |
| | generation) associated with each transaction. |
| | Payment Use Case: Considers factors such as, for example, energy |
| | efficiency of payment processing infrastructure, carbon footprint of |
| | transaction-related activities, and sustainability of materials used in |
| | physical transactions. |
| | Frictionless Payment Focus: Emphasizes the environmental |
| | footprint of frictionless transactions, encouraging eco-friendly payment |
| | practices. |
| | Goal: A higher environmental score reflects transactions with lower |
| | environmental impact, aligning with sustainable and energy-efficient |
| | payment practices. |
| Social Score: | Calculation Basis: Analyzes the social implications of transactions, |
| | including customer satisfaction, inclusivity, and data privacy. |
| | Payment Use Case: In payment transactions, customer satisfaction |
| | is measured by transaction speed and overall user experience, inclusivity |
| | considers accessibility, and data privacy evaluates security measures. |
| | Frictionless Payment Focus: Prioritizes user satisfaction, inclusivity |
| | in frictionless transactions, and adherence to data privacy standards. |
| | Goal: A higher social score signifies transactions that contribute |
| | positively to customer satisfaction, inclusivity, and data privacy in the |
| | payment ecosystem. |
| Governance | Calculation Basis: Assesses governance aspects related to outdated |
| Score: | payment practices, including transparency, compliance, and ethical |
| | practices. |
| | Payment Use Case: Examines the transparency of transaction |
| | details, adherence to regulatory standards, and alignment with ethical |
| | principles in payment transactions. |
| | Frictionless Payment Focus: Emphasizes transparent and compliant |
| | governance practices in frictionless payment methods. |
| | Goal: A higher governance score indicates transactions that |
| | demonstrate transparency, compliance with regulations, and ethical |
| | practices, fostering trust in the payment system. |

As shown in FIG. 1, and consistent with the above, the environmental aspects of the transactions are compiled into an environmental score 118; the social aspects of the transactions are compiled into a social score 120; and the governance aspects of the transactions are compiled into a governance score 122.

The environmental score 118 is representative of the environmental impact of resource-intensive processes (e.g., energy consumption, carbon emissions, waste generation, etc.) for each transaction. The social score 120 is representative of the social implications of slow and inefficient transactions (e.g., customer satisfaction, inclusivity, data privacy, etc.) for each transaction. And, the governance score 122 is representative of governance aspects related to outdated payment practices (e.g., transparency, compliance, ethical practices, etc.) for each transaction.

In connection with an example implementation of the above, certain example data (e.g., factors, considerations, impacts, etc.) is presented below for purposes of illustration, and, which may be different in other examples or implementations of the present disclosure.

As it relates to an environmental score, consistent with the above, the calculation is based on resource-intensive processes (e.g., energy consumption, carbon emissions, waste generation, etc.) associated with each transaction, where two transaction are included in Table 2, below, with the associated usages:

TABLE 2

| | Energy | Carbon | Waste |
|---|---|---|---|
| Transaction | Consumption | Emission | Generation |
| Transaction_1 | 30 units | 20 units | 10 units |
| Transaction_2 | 25 units | 15 units | 5 units |

As it relates to the payment use case for the environmental score, the program host 116 relies on factors, such as, for example, energy efficiency of the payment processing infrastructure, carbon footprint of transaction-related activities, and sustainability of materials used in physical transactions. In this specific example, the energy efficiency score for the transactions is determined to be 20 and the sustainability score for the transactions is determined to be 18. Consequently, for a frictionless payment in the above example transactions, transaction_1 has an environmental score of 15 units, while transaction_2 has an environmental score of 10 units.

Next, the transactions are aggregated, by the program host 116, to add the environmental impact of resource-intensive processes (e.g., energy consumption, carbon emissions, waste generation) associated with each transaction: transaction 1: Energy Consumption=30 units, Carbon Emissions=20 units, Waste Generation=10 units; transaction 2: Energy Consumption=25 units, Carbon Emissions=15 units, Waste Generation=5 units. And then, the program host adds, for the payment use case, factors such as energy efficiency of payment processing infrastructure, carbon footprint of transaction-related activities, and sustainability of materials used in physical transactions: energy efficiency=20 and sustainability=18. And, the program host 116 adds, for frictionless payment focus, the environmental footprint of frictionless transactions, encouraging eco-friendly payment practices: frictionless transaction 1: environmental Impact=15 units; and frictionless transaction 2: environmental Impact=10 units. The environmental score, in this example, is then: (30+20+10)+ (25+15+5)+ (20+18)-(15+10)=118. Here, a higher environmental score reflects transactions with lower environmental impact, aligning with sustainable and energy-efficient payment practices.

As it relates to a social score, consistent with the above, the calculation is based on social implications of transactions, including customer satisfaction, inclusivity, and data privacy, each associated with the transactions, where two transaction are included in Table 3, below, with the associated usages:

TABLE 3

| | Customer | | Data |
|---|---|---|---|
| Transaction | Satisfaction | Inclusivity | Privacy |
| Transaction_1 | 70% | 55% | 45% |
| Transaction_2 | 25% | 30% | 50% |

As it relates to the payment use case for the social score, the program host 116 relies on customer satisfaction as measured by transaction speed and overall user experience, inclusivity considers accessibility, and data privacy evaluates security measures. Example values for these factors include: transaction speed=35%, user experience=60%, accessibility=45%, and security measures=70%.

Next, the transactions are aggregated, by the program host 116, to add the social implications of transactions, including customer satisfaction, inclusivity, and data privacy: transaction 1: customer satisfaction=70%, inclusivity=55%, data privacy=45%; and transaction 2: customer satisfaction=25%, inclusivity=30%, data privacy=50%. And, the program host 116 adds, for the payment use case, in payment transactions, customer satisfaction as measured by transaction speed and overall user experience, inclusivity considering accessibility, and data privacy evaluated as security measures: transaction speed=35%, user experience=60%, accessibility=45%, and security measures=70%. And, the program host 116 adds, for frictionless payment focus, prioritized user satisfaction, inclusivity in frictionless transactions, and adherence to data privacy standards: frictionless transaction 1: user satisfaction=55%, inclusivity=50%, data privacy=78%; and frictionless transaction 2: user satisfaction=52%, inclusivity=58%, data privacy=72%. The social score, in this example, then, is equal to the sum of the scores, or Social Score=(70+55+45)+ (25+30+50)+ (35+60+45+70)-(55+50+78)-(52+58+72)=120. Here, again, a higher social score reflects positive contributions to customer satisfaction, inclusivity, and data privacy in the payment ecosystem.

As it relates to a governance score, consistent with the above, the calculation is based on outdated payment practices, including transparency, compliance, and ethical practices, each associated with the transactions, where two transaction are included in Table 4, below, with the associated usages:

TABLE 4

| | | | Ethical |
|---|---|---|---|
| Transaction | Transparency | Compliance | Practices |
| Transaction_1 | 65% | 50% | 36% |
| Transaction_2 | 88% | 92% | 85% |

As it relates to the payment use case for the social score, the program host 116 examines the transparency of transaction details, adherence to regulatory standards, and alignment with ethical principles in the payment transactions.

The transactions are aggregated, by the program host 116, to add the governance aspects related to outdated payment practices, including transparency, compliance, and ethical practices: transaction 1: transparency=65%, compliance=50%, ethical practices=36%; and transaction 2: transparency=88%, compliance=92%, ethical practices=85%. The program host 116 adds, for the payment use case, the transparency of transaction details, adherence to regulatory standards, and alignment with ethical principles in payment transactions: transparency of transaction details=80%, adherence to regulatory standards=90%, ethical alignment=85%. And, the program host 116 adds, for Frictionless Payment Focus: Emphasizes transparent and compliant governance practices in frictionless payment methods: frictionless transaction 1: Transparency=92%, Compliance=95%, Ethical Practices=90%; and frictionless transaction 2: Transparency=90%, Compliance=94%, Ethical Practices=88%. The

The governance score, in this example, is equal to the sum of the scores, or (65+50+36)+ (88+92+85)+ (80+90+85)-(92+95+90)-(90+94+88)=122. Here, again, a higher social score indicates transactions that demonstrate transparency, compliance with regulations, and ethical practices, fostering trust, etc.

As further shown in FIG. 1, in this example, the program host 116 is configured to initialize or start with an impact score for the account of the user 112 to/of zero and to then calculate, for each transaction to the account, each of the environmental score 118, the social score 120, and the governance score 122, based on the associated rules and criteria of the ESG framework (as included in and/or accessible to the program host 116). The program host 116 is configured to then aggregate, for each transaction, the environmental score 118, the social score 120 and the governance score 122 (which may be calculated consistent with the example above) to an impact score (e.g., sum, average, or otherwise combine, etc.). It should be understood that the specific ESG framework defines calculations and actions. Here, for example, the ESG score calculation includes, for each transaction, calculated scores for environmental, social, and governance impacts, and then, summing the individual scores to obtain a total ESG score for the transaction. In this way, in this example, the impact score is initially determined on a transaction-by-transaction basis, and is unique to the particular transaction.

The program host 116 is further configured to then combine the impact scores for the different transactions relating to the account of the user 112 into a total impact score for the account (e.g., an ESG score, etc.) and adjust the initialized score for the user 112. In combining the impact scores, in this example embodiment, the program host 116 may be configured to average the impact scores for each of the transactions, for a defined interval (e.g., day, week, month, etc.). It should be appreciated that other manners or intervals of combining the individual impact scores for the individual transactions may be employed in other embodiments. It should also be appreciated that the total impact score for the account of the user 112 may extend over a life of the account, or it may be set to extend for a desired period (e.g., annually and then reset, etc.).

What's more, it should be further appreciated that while each of the environmental score 118, the social score 120, and the governance score 122 are included, for each transaction, in the total impact score for the account of the user 112, less than the three specified scores may be included for some or all transactions in other system embodiments. For example, only the highest score, or the lowest score, may be included (or excluded) in some aggregation and/or combinations, etc. (e.g., in general or for particular transactions (e.g., for transactions involving particular merchants or MCCs, etc.), etc.).

That said, after the total combined impact score for the account of the user 112 is determined, the program host 116 is configured to indicate the total combined impact score to the user 112.

In connection therewith, the program host 116 may be configured to report the total impact score (and/or the constituent environmental, social and/or governance scores 118-122) to the user 112, via the issuer 108, for example, at a wallet associated with the user 112 (e.g., at the communication device 114, etc.), or at the virtual location of the first party 102, in connection with the user 112 proceeding in a checkout sequence, or a virtual location of the issuer 108 (e.g., as part of an account summary, etc.). The total impact score may be accompanied by a description of the ESG framework, which is used to compute the total impact score, and potentially, also comparison examples and/or data (for other transactions, activities, etc.) to further aid the user 112 in understanding the total impact score and/or constituent scores relating to his/her transaction(s) and account.

It should be appreciated that the total impact score for the account of the user 112 may be indicated to the user 112 regardless of the score (or threshold), or potentially based on one or more thresholds. In one example embodiment, the program host 116 is configured to determine whether the total impact score satisfies one or more thresholds. That is, for example, the ESG framework relies on a threshold check, where if the total impact score falls below a defined threshold, the transaction is considered to have low ESG performance. When the threshold(s) is(are) satisfied, the program host 116 is configured to do nothing.

Conversely, when the one or more thresholds is not satisfied, the program host 116 is configured to notify the user 112 of the total impact score and/or failure of the total impact score to satisfy the one or more thresholds. The notification may be delivered, again, through one or more virtual locations associated with the first party 102 (e.g., as part of a checkout sequence, etc.), the issuer 108, or other party associated with and/or interacting with the user 112 in association with the payment account.

Further, in general when there is insufficient use of frictionless payment, or the total impact score fails to satisfy the one or more thresholds, the program host 116 is further configured to promote frictionless payment, with the account, to the user 112. That is, the program host 116 is configured to notify the user 112 of the total impact score being unsatisfactory and the potential improvement or benefits of the total impact score through use of frictionless payment options for performing transactions to the account of the user 112 (e.g., reduced carbon footprint, enhanced user experience, streamlined governance, etc.). The improvement or benefits may be general for transactions, or specific to one or more of the transactions included in the transaction data for the account of the user 112. In addition, the improvement based on frictionless payment may be presented in a manner specific to the different scores, such as, for example, reduced carbon footprint, enhanced user experience, and/or streamlined governance practice, etc. In various embodiments, the program host 116 may be configured to calculate simulated total impact scores based on enrollment into frictionless payment, where the impact score for transactions included in a defined interval are recalculated with frictionless payment as the payment method. What's more, the different types of frictionless payments, which are distinct based on authentication techniques, may further be associated with different impact scores. As such, in addition, the program host 116 may be configured to calculate simulated total impact scores for different types of or authentication options for frictionless payment, e.g., biometric versus contactless versus OTP, etc. That is, the different types of frictionless payments are categorized by the associated different authentication options. As such, an impact score may be simulated for biometric authentication as one type of frictionless payment, while another impact score may be calculated for OTP authentication as another type of frictionless payment. Generally, the total impact score is different for the different authentication options and/or payment types. Each of the simulated total impact scores may be included in the notification to the user 112, whereby the user 112 is informed of a present total impact score and a potential total impact score for enrolling in one or more frictionless payment methods (or authentication options).

It should be appreciated that the simulated total impact scores may be calculated in real time, in connection with the transaction, or may be pre-calculated at one or more intervals for the user 112, or potentially, may be estimated based on one or more aspects of the user 112 and/or transaction history of the user 112. It should be appreciated that the frictionless payment methods may further be associated with one or more incentives and/or rewards (e.g., loyalty points, etc.).

Based on the above, for a given transaction, the user 112 may initiate the transaction by selecting a payment option (e.g., from multiple payment options (e.g., debit card, credit card, cash, etc.), etc.). In response to the selected option, the first party 102 is configured to solicit impact score(s) related to frictionless payment, thereby permitting the program host 116 to promote frictionless payment options. In response, the program host 116 is configured to notify the user 112 of the total impact score, as explained above, and may further be configured to solicit consent of the user 112 to enroll in one of the frictionless authentication options (or payment method(s)).

In turn, the first party 102 displays the total impact score(s) (or potentially simulated total impact score(s) from the program host 116) for the given transaction to the user 112. In response, the user 112 may opt to enroll by selecting one of frictionless payment options, or specific authentication options for payment, etc., as consent, in general as to the payment account of the user 112 at the communication device 114 or specific to the first party 102, for example. Consistently, the program host 116 is configured to enable one or more existing non-frictionless payments (e.g., 2FA, etc.) with either one-click purchases or biometric authentication or another option selected by the user 112, each of which are considered herein to be frictionless payments, and the first party 102 is configured to process (e.g., initiate, etc.) the given transaction consistent with the selected payment option and authentication option. In connection therewith, the program host 116 may be further configured to provide one or more incentives and/or rewards (e.g., loyalty points, etc.) for enrolling in frictionless payments.

It should be appreciated that the total impact score for the account of the user 112 may be reset to zero upon enrollment in frictionless payment, or not. When reset, the total impact score generally shows immediate improvement for the additional transaction(s). When not reset, the total impact score improves over time, as more frictionless payment type transactions are performed by the user 112.

Subsequently, the program host 116 is configured to continue to calculate, for each additional transaction to the account, the environmental score 118, the social score 120, and the governance score 122, based on the associated rules and criteria of the ESG framework. The program host 116 is configured to then aggregate, for each transaction, the environmental score 118, the social score 120, and the governance score 122 to the impact score for the transaction (e.g., again summed, averaged, or otherwise combined, etc.) and to combine the impact scores for the different transactions into the total impact score for the account. That is, the program host 116 may be further configured to provide continuous monitoring of the total impact score, whereby transactions are continuously monitored, and the total impact score is updated consistent with the above, in real-time (e.g., within minutes, etc.) or near real time (e.g., within hours, etc.), as the user makes frictionless transactions.

The program host 116 may be configured to also, potentially, offer personalized recommendations, which may be based on purchase behavior of the user 112, for additional sustainable practices considered in connection with ESG objectives, which are beyond frictionless payments. It should be appreciated that the indication to the user 112 need not be limited to the total impact score, or the constituent scores. The total impact score may be accompanied by additional activities related to or unrelated to payment transactions, which may be consistent with the user's transaction data, activities, etc., and also may further improve the user's performance relative to the ESG framework. Such additional activities or practices may be linked to the payment account, or not.

With reference again to FIG. 1, while one first party 102, one acquirer 104, one processing network 106, one issuer 108, one user 112, and one communication device 114 are included in the system 100 illustrated in FIG. 1, it should be appreciated that any number of these entities, devices, and/or persons (and their associated components) may be included in the system 100, or may be included as a part of systems in other embodiments, consistent with the present disclosure.

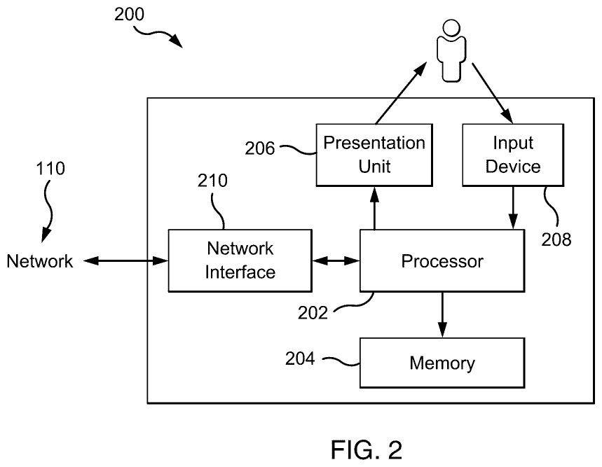

FIG. 2 illustrates an example computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In particular, in the example system 100 of FIG. 1, each of the first party 102, the acquirer 104, the processing network 106, the issuer 108, and the program host 116 may be understood as including, or being implemented in, a computing device (e.g., a platform computing device, etc.) consistent with computing device 200, coupled to the network 110. In addition, the user's communication device 114 may be considered a computing device consistent with computing device 200. That said, however, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, data relating to installment transactions, charges, codes and associated terms and criteria, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein whereby, in connection with such performance, the computing device 200 may be transformed into a special-purpose computing device, for example, configured to effect frictionless transactions in the system 100. It should be appreciated that the memory 204 may include a variety of different memories, each implemented in one or more of the functions or processes described herein.

In addition in the example embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., total impact scores, etc.), either visually or audibly, to a user of the computing device 200, for example, the user 112, users associated with other parts of the system 100, etc. Various interfaces (e.g., as defined by network-based applications, webpages, short message service (SMS) messages, emails, etc.) may also be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

The computing device 200 also includes an input device 208 that receives inputs from the user of the computing device 200 (i.e., user inputs) such as, for example, entry of account numbers, selection to enroll for frictionless transactions, etc. The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks, including the network 110. Further, in some example embodiments, the computing device 200 may include the processor 202 and one or more network interfaces (including the network interface 210) incorporated into or with the processor 202.

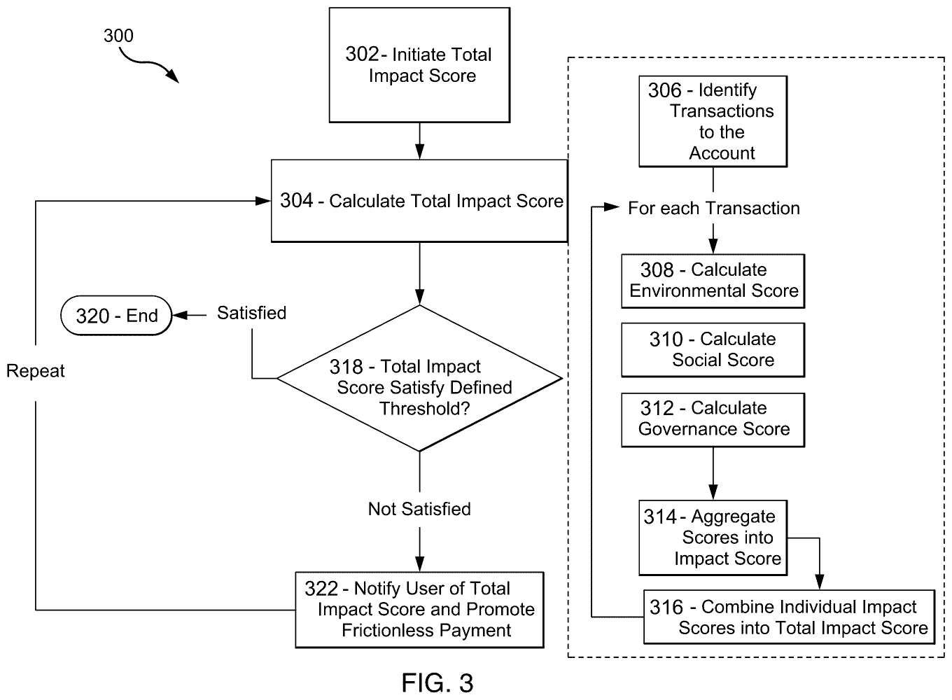

FIG. 3 illustrates an example method 300 for use in assessing and addressing data related to transactions initiated by users. The example method 300 is described as implemented in the system 100 with reference made to the program host 116, and further with reference to the computing device 200. However, it should be understood that the method 300 is not limited to this configuration of the system 100, as the method 300 may be implemented, at least in part, in other parts of the system 100, or in multiple other computing devices or systems. As such, the methods herein should not be understood to be limited to the example system 100 or the example computing device 200, and likewise, the systems and the computing devices herein should not be understood to be limited to the example method 300.

At the outset in the method 300, it should be appreciated that the user 112 is not enrolled in frictionless payments, for/from the account issued to the user 112 by the issuer 108. As such, prior transactions by the user 112, via the account, have not been frictionless type transactions. Consequently, it should be understood that an opportunity exists to improve the user's performance under the ESG framework described above for the issued account. It should further be appreciated that the method 300 may be repeated at one or more intervals (e.g., regular, irregular, or event-based, etc. intervals) for the account, if the user 112 opts not to enroll consistent with the promoting of the frictionless payment as explained below.

It should also be appreciated that method 300 may be implemented for various other accounts, either issued to the user 112 or to other users.

Initially, at 302, the program host 116 initializes the total impact score, which is specific to the account of the user 112, to zero, or some other starting value, baseline, etc., as desired. While the total impact score is specific to the account of the user 112 in this example, it should be understood that the score may be specific to the user 112, but also associated with multiple accounts (e.g., a user-specific total impact score, etc.).

The program host 116 then calculates, at 304, the total impact score for the account. In doing so, the program host 116 performs the steps illustrated in the dotted box in FIG. 3, where each is a subprocess of calculating the total impact score.

As shown, the program host 116 identifies, at 306, the transactions to the account of the user 112. The transactions may include any transactions between the user 112 and the first party 102, and other first parties. In general, the program host 116 identifies all transactions to the account of the user 112. In one or more embodiments, the program host 116 may identify a subset of the transactions to the account of the user 112, based on MCC, amount, temporal parameters, etc.

And then, for each transaction identified, the program host 116 proceeds to calculate the environmental score 118, the social score 120, and the governance score 122.

In particular, at 308, the program host 116 calculates the environmental score 118. As described, the environmental score 118 includes an assessment of the environmental impact of resource-intensive processes (e.g., energy consumption, carbon emissions, waste generation, etc.) for each payment transaction, and the program host 116 calculates the environmental score 118 based on a detailed analysis of the environmental impact associated with resource-intensive processes linked to each transaction.

For energy consumption, for example, the program host 116 accesses data related to factors, including, for example, energy efficiency of the payment processing infrastructure, mode of transaction (online, in-person), and data centers involved, etc. For carbon emissions, the program host 116 relies on data related to, without limitation, transportation, data storage, and processing, etc. And, for waste generation, the program host 116 accesses data related to factors including, without limitation, sustainability of materials used in card production or any physical elements associated with the transaction, etc. In connection therewith, the program host 116 may use specific metrics, such as, for example, energy efficiency ratios and emission factors, and may additionally calculates the environmental score by applying algorithms to derive a comprehensive environmental score for each transaction.

At 310, the program host 116 calculates the social score 120. Again, the social score 120 includes an assessment of social implications of slow and inefficient transactions (e.g., customer satisfaction, inclusivity, data privacy, etc.). In more detail, the program host 116 calculates the social score 120 for payment use cases involving a nuanced evaluation of the social implications associated with each transaction.

For social impact, the program host 116 accesses data related to, without limitation, assessment of customer satisfaction, inclusivity, and data privacy aspects. Customer satisfaction is indicated in data related to transaction speed, ease of use, and overall user experience. Inclusivity considers factors such as, for example, accessibility and support for user demographics. And, data privacy involves evaluating the security measures implemented during the transaction process. The program host 116 accesses the specific data, and employs specific metrics, such as transaction completion time, accessibility features, and privacy compliance standards. The program host 116 then calculates the social score 120 by applying algorithms to derive the level of social responsibility demonstrated by each transaction.

And, at 312, the program host 116 calculates the governance score 122. The governance score 122 includes an assessment of governance aspects related to outdated payment practices (e.g., transparency, compliance, ethical practices) for each transaction. In more detail, the program host 116 calculates the governance score 122 meticulously through evaluating governance aspects related to outdated payment practices related to transparency, compliance, ethical practices, etc., for each transaction.

For example, transparency is gauged by data indicative of considering how clearly transaction details are communicated to the user. Compliance involves data related to adherence to regulatory standards and industry best practices. And, ethical practices considers data indicative of alignment of the transaction with ethical principles. The program host 116 accesses the above data and employs specific metrics, such as, for example, transparency ratios, compliance checks, and ethical practice criteria. The program host 116 then calculates the social score 120 by applying algorithms to derive the transaction's adherence to governance standards and ethical practices.

For the transaction, the program host 116 then aggregates, at 314, the environmental score 118, the social score 120, and the governance score 122, into an impact score for the transaction.

For instance, in a first example transaction, the environmental score is calculated to be 7; the social score is calculated to be 8; and the governance score is calculated to be 9. The different scores are aggregated together for an impact score of 24 for the first example transaction, where the aggregation of the scores is the sum of the scores. In a second example transaction, the environmental score is calculated as 6; the social score is calculated as 8; and the governance score is calculated as 8. In this example transaction, the aggregate impact score is 22 (again, where the aggregation of the scores is the sum of the scores).

With further reference to FIG. 3, after an impact score is calculated for each identified transaction to the account of the user 112, the program host 116 combines, at 316, the individual impact scores for the identified transactions into a total impact score for the account. In this example embodiment, the combination of the individual impact scores includes an average of the scores. As such with regard to the first and second example transactions above, the program host 116 combines the scores into a total impact score of 23 (i.e., (24+22)/2=23).

Next in the method 300, the program host 116 determines, at 318, whether the total impact score satisfies a defined threshold. The defined threshold may be set based on empirical data, experimentation, or other means, etc., where the threshold is indicative of a goal associated with ESG, etc. In this example embodiment, the defined threshold is set to 24. When the defined threshold is satisfied by the total impact score, in this example embodiment, the program host 116 ends the method 300, at 320. Conversely, when the defined threshold is not satisfied by the total impact score, the program host 116 notifies the user 112, at 322, about the total impact score and promotes frictionless payment as a mechanism to improve the total impact score.

The notification may be delivered to the user 112 at the communication device 114, for example, through a website associated with the first party 102 or the issuer 108 accessed by the communication device 114, or in a network-based application included in the communication device 114.

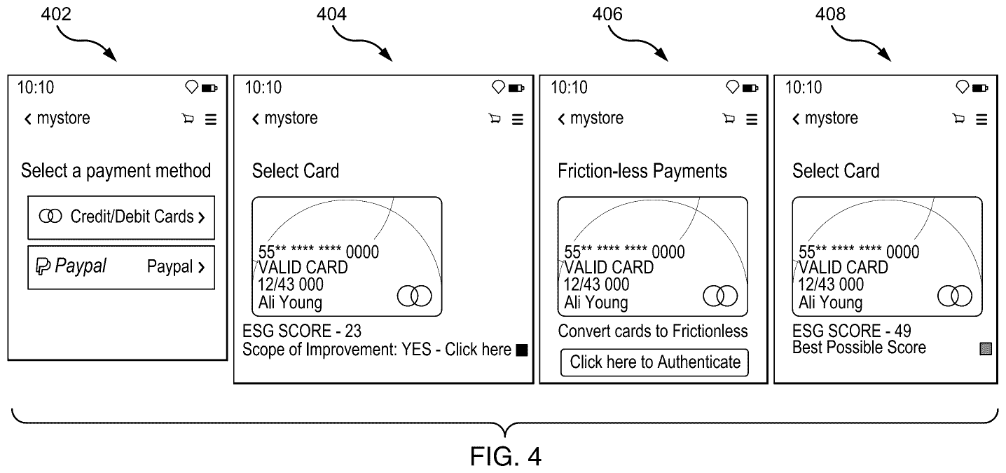

In connection with notifying the user 112 about the total impact score for the user's account, FIG. 4 illustrates a sequence of example interfaces 402-408, which may be displayed to the user 112 at the communication device 114 to promote frictionless payment.

As shown in the example interface 402, the user 112 is proceeding to check out for a transaction with the first party 102. In doing so the user 112 selects a payment option, which in this example includes a credit/debit card. Upon selection of the payment option, the example interface 404 is displayed to the user 112. As shown, an image of a payment card associated with the selected account is displayed, with the last four digits of the account number illustrated to the user 112 as to which account the payment card is associated. In addition, just below the payment card, the example interface 404 includes the total impact score, or ESG score, for the account of the user 112, posted to the user 112, where the score is shown as 23 consistent with the above example.

It should be appreciated that the program host 116 provides the ESG score(s), as named in interface 404, as part of a value added service (VAS) to the issuer 108. The ESG score may be appended to the interface 404, by the program host 116, the issuer 108, or a combination thereof. The program host 116 provides the specific scores, for example, as part of the value-added offering for the issuer 108 of the account. That is, when the transaction is initiated, the first party 102 and/or the issuer 108 contact the program host 116, with a request for the total impact score (e.g., via an application programming interface API), etc.). In turn, the program host 116 calculates the total impact score for the account, consistent with the description of method 300 and returns the ESG score to the first party 102 and/or the issuer 108 for display as part of interface 404.

It should also be appreciated that, in some examples, the ESG score may be calculated at an interval independent of the instant transaction and stored in memory (e.g., in the program host 116, etc.). In such examples, in response to the transaction, the program host 116 retrieves the ESG score(s) from the memory, rather than calculating the same in real time.

Noting a lack of frictionless payment, the program host 116 also returns an indicator of improvement for enrolling in frictionless payment. An option to enroll in frictionless payment is included at the bottom of interface 404 (i.e., Scope of Improvement: Yes—click Here). In this example embodiment, upon selecting the option, the user 112 is shown the interface 406, which includes a frictionless transaction method (e.g., based on regional regulatory guidelines, etc.). It should be appreciated that in other examples, the interface may include multiple different frictionless payment methods, whereby the user 112 is solicited not only to enroll, but to select a particular frictionless payment method (or authentication option). That is, additional ESG scores may be included in the interface 404, as simulated score(s) for different authentication options (broadly, different frictionless payment methods).

While not shown in FIG. 4, the interface may include a simulated total impact score for the user 112, for the frictionless payment methods or authentication options specific to the methods, which is instructive of what the total impact score would or could be based on enrollment. For example, a biometric authentication option along with an ESG score for that option may be displayed, with an OTP authentication option along with an ESG score for that option, as additional authentication options to the user 112. The simulated total impact score may also be calculated by the program host 116 in real time, or retrieved from a data structure of simulated total impact scores for the user 112 (or based on a transaction history of the user 112), etc. In this way, the user 112 is informed about the potential change in the total impact score for selecting to enroll in one of the frictionless payment methods.

It should be appreciated that one ore more ESG scores can be shown against each authentication option in various scenarios. For example, in one scenario the ESG scores may be displayed on a payment gateway webpage or authentication webpage, which are displayed after a specific payment option is selected by the user. The authentication webpage may correspond to a page displayed in a mobile application or may be a webpage within a web browser. It is also to be appreciated that the ESG score can be shown against some authentication options while for some authentication options there may be no ESG score. The authentication options can be shown in various ways, including for example in various tabs where each tab correspond to an authentication option. The ESG score can be displayed by a processing network or an issuer or a payment gateway or a combination of one or more of these. The ESG score may aid the user to opt for an authentication option that saves, for example, carbon footprint while being securely authenticating the transaction. In some scenarios, the authentication option may be the first stage during a transaction journey when one or more ESG scores are shown while in some scenarios the ESG scores may be shown in earlier stages of the transaction journey, for example along with display of payment options.

In various embodiments, a number of steps can be performed to enable display of the ESG scores for various authentication options. The steps may include accessing, by a computing device associated with the processing network or the issuer or the payment gateway, a first ESG score associated with a first authentication option and a second ESG score associated with a second authentication option, where in the first ESG score is different than the second ESG score. The first ESG score and the second ESG score may be a pre-stored value retrieved from an appropriate database or may be calculated in real time.

In one embodiment, a user may buy goods/services at an online store or online application hosted and managed by the first party. The online store may include e-commerce websites, online retail stores, e-business service providers, etc. The user may make the payment transaction to the first party on the interface through the payment gateway using the payment option. The payment gateway further facilitates the user to authenticate the payment transaction at an issuer interface hosted and managed by the issuer. A payment transaction request is initiated at the interface and is sent to the issuer, via the processing network. The issuer redirects the user from the interface to the issuer interface for authenticating the payment transaction. On this issuer interface, the user is provided with the plurality of authentication options along with ESG scores to select an authentication option for validating authentication of the payment card and/or the user.

When the user 112 selects to enroll in the frictionless transaction method (i.e., Card ending in 0000, as shown in interface 406), the user 112 is asked to authenticate (e.g., during two-factor authentication, OTP, or password, etc.), whereby the frictionless transaction method is activated and/or the user 112 is enrolled. In addition, the first party 102 processes the transaction consistent with the selections of the user 112.

Thereafter, following a subsequent transaction, the example interface 408 may be displayed to the user 112, where the option to enroll for frictionless payment is omitted, in favor of an indicator of the enrollment (e.g., a green indicator, a shaded indicator, etc.) and the ESG score, which is higher than prior (e.g., is 49 in the example of interface 408, etc.). The ESG score is associated with a “Best Possible Score” flag in this example, but may include other options associated with one or more ESG objectives in other examples.

Referring again to FIG. 3, the method 300 then repeats, whereby the program host 116 returns to step 304, at one or more regular or irregular intervals. Optionally, the program host 116 may notify the user 112 of the total impact score, at the one or more intervals, or some other timing (e.g., continuously, in real time, following each transaction, etc.), so that the user 112 is informed of improvement to the total impact score through use of frictionless payment, when enrolled. For example, as shown in the example interface 408, the total impact score for the account of the user 112 has been raised from the original score of 23 to an improved total impact score of 49 through transactions subsequent to enrollment in frictionless payment.

In addition to notifying the user 112 about the total impact score and promoting frictionless payment, the program host 116 may notify the user 112 about additional activities which may be of benefit to one or more goals associated with the ESG framework, or other assessments determined to be relevant to the user 112.

Personalized recommendations for additional sustainable practices beyond frictionless payments to improve the ESG score may include, for example: Green Spending Suggestions, which encourage users to make purchases from environmentally conscious and sustainable businesses; Highlight or offer incentives for eco-friendly products; Carbon Offset Contributions, which suggest voluntary carbon offset programs for users to contribute to environmental initiatives; Provide information on projects that reduce or capture carbon emissions; Sustainable Loyalty Programs, which introduce loyalty programs that reward users for sustainable choices; Educational Resources, which offer access to educational materials on sustainable living and environmental conservation; Provide insights into the impact of different lifestyle choices, etc.

It should be appreciated that the functions described herein, in some embodiments, may be described in computer executable instructions stored on a computer readable media, and executable by one or more processors. The computer readable media is a non-transitory computer readable media. By way of example, and not limitation, such computer-readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) accessing transaction data representative of a plurality of transactions to an account, each of the transactions involving a user; (b) for each of the plurality of transactions: (i) calculating an environmental score based on environmental impact of the transaction; (ii) calculating a social score, based on social impact of the transaction; (iii) calculating a governance score, based on governance impact of the transaction; and (iv) aggregating the environmental score, the social score and the governance score into an impact score; and (e) combining the impact scores for the plurality of transactions into a total impact score for the account; and (d) notifying the user of the total impact score.

The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail (but this does not mean any aspect of the recited claims is well-known). In addition, advantages and improvements that may be achieved with one or more example embodiments of the present disclosure are provided for purpose of illustration only and do not limit the scope of the present disclosure, as example embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of the embodiments has been provided for purposes of illustration and description. It is not intended to be exhaustive or to limit the disclosure. Individual elements intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for assessing data related to transactions initiated by users, the method comprising:
accessing transaction data representative of a plurality of transactions to an account, each of the transactions involving a user;
for each of the plurality of transactions:
calculating, by a computing device, an environmental score based on environmental impact of the transaction;
calculating, by the computing device, a social score, based on social impact of the transaction;
calculating, by the computing device, a governance score, based on governance impact of the transaction; and
aggregating, by the computing device, the environmental score, the social score and the governance score into an impact score; and
combining, by the computing device, the impact scores for the plurality of transactions into a total impact score for the account; and
notifying the user of the total impact score.

2. The computer-implemented method of claim 1, wherein calculating the environmental score includes assessing electricity usage, carbon emission data, and ethical considerations relevant to the transaction; and
wherein calculating the social score includes evaluating industry-specific metrics, ethical data, and transaction purpose associated with the transaction; and
wherein calculating the governance score involves considering industry-specific data and supply chain information impacting the transaction.

3. The computer-implemented method of claim 1, wherein aggregating the environmental score, the social score and the governance score into the impact score for the transaction includes summing the environmental score, the social score and the governance score.

4. The computer-implemented method of claim 1, wherein combining the impact scores into the total impact score includes averaging the impact scores for the plurality of transactions.

5. The computer-implemented method of claim 1, wherein notifying the user includes:
determining, by the computing device, that the total impact score fails to satisfy a defined threshold; and
notifying the user in response to the total impact score failing to satisfy the defined threshold.

6. The computer-implemented method of claim 5, wherein notifying the user includes posting the total impact score to an interface at a communication device of the user.

7. The computer-implemented method of claim 1, wherein notifying the user includes prompting an activity to improve the total impact score.

8. The computer-implemented method of claim 7, wherein the activity to improve the total impact score includes frictionless payment with the account.

9. A computer-implemented method for assessing data related to transactions initiated by users, the method comprising:
displaying a total impact score for a user to the user and an option to improve the total impact score, the total impact score based on an environmental social and governance (ESG) assessment;
receiving, at a computing device, a selection of the option;
in response to selection of the option, causing, by the computing device, a plurality of frictionless payment methods to be displayed to the user, each frictionless payment method associated with a simulated total impact score specific to the frictionless payment method;
receiving, by the computing device, a selection of one of the frictionless payment methods;
in response to the selection of the one of the frictionless payment methods, authenticating the user; and
in response to the user being authenticated, processing the payment using the selected one of the frictionless payment methods.

10. A non-transitory computer readable storage medium having executable instructions for assessing data related to transactions initiated by users, which when executed by a processor, cause the processor to:
access transaction data representative of a plurality of transactions to an account, each of the transactions involving a user;
for each of the plurality of transactions:
calculate an environmental score based on environmental impact of the transaction;
calculate a social score, based on social impact of the transaction;
calculate a governance score, based on governance impact of the transaction; and
aggregate the environmental score, the social score and the governance score into an impact score; and
combine the impact scores for the plurality of transactions into a total impact score for the account; and
notify the user of the total impact score.

11. The non-transitory computer readable storage medium of claim 10, wherein the executable instruction, when executed by the processor cause the processor, in calculating the environmental score, to assess electricity usage, carbon emission data, and ethical considerations relevant to the transaction; and
wherein the executable instruction, when executed by the processor cause the processor, in calculating the social score, to evaluate industry-specific metrics, ethical data, and transaction purpose associated with the transaction; and
wherein the executable instruction, when executed by the processor cause the processor, in calculating the governance score, to rely on industry-specific data and supply chain information impacting the transaction.

12. The non-transitory computer readable storage medium of claim 10, wherein the executable instructions, when executed by the processor cause the processor, in aggregating the environmental score, the social score and the governance score into the impact score for the transaction, to sum the environmental score, the social score and the governance score.

13. The non-transitory computer readable storage medium of claim 10, wherein the executable instruction, when executed by the processor cause the processor, in combining the impact scores into the total impact score, to average the impact scores for the plurality of transactions.

14. The non-transitory computer readable storage medium of claim 10, wherein the executable instruction, when executed by the processor cause the processor, in notifying the user, to:
determine that the total impact score fails to satisfy a defined threshold; and
notify the user in response to the total impact score failing to satisfy the defined threshold.

15. The non-transitory computer readable storage medium of claim 14, wherein the executable instruction, when executed by the processor cause the processor, in notifying the user, to post the total impact score to an interface at a communication device of the user.

16. The non-transitory computer readable storage medium of claim 10, wherein the executable instruction, when executed by the processor cause the processor, in notifying the user, to prompt an activity to improve the total impact score.

17. The non-transitory computer readable storage medium of claim 16, wherein the activity to improve the total impact score includes frictionless payment with the account.

18. A method for use in assessing data related to transactions initiated by users, the method comprising:
providing one or more payment options to a user for a transaction;
in response to selecting one of the one or more payment options, displaying, to the user, by a computing device, a plurality of authentication options corresponding to a selected one of the payment options along with one or more environmental, social and governance (ESG) related scores for each authentication option;
receiving a selection of one of the plurality of authentication options; and
processing a payment for the transaction using the selected one of the plurality of authentication options.
